(19) United States
(12) Patent Application Publication
(10) Pub. No.: US 2024/0212053 A1
(43) Pub. Date: Jun. 27, 2024

(54) SYSTEM AND METHOD FOR PROVIDING USAGE OR BEHAVIOR BASED INSURANCE INFORMATION

(71) Applicant: RAKUTEN SYMPHONY SINGAPORE PTE. LTD., Capitagreen (SG)

(72) Inventor: Viswanathan VENKATARAMAN, Capitagreen (SG)

(73) Assignee: RAKUTEN SYMPHONY SINGAPORE PTE. LTD., Capitagreen (SG)

(21) Appl. No.: 17/802,381

(22) PCT Filed: Jun. 24, 2022
(86) PCT No.: PCT/US2022/034826

§ 371 Date: Dec. 28, 2023

(51) Int. Cl. G06Q 40/08; G06Q 30/0201

(52) U.S. Cl. CPC G06Q 40/08; G06Q 30/0201

(57) ABSTRACT

A system, performed by at least one processor of a computing device, for providing usage or behavior based insurance information includes a provisioning module that communicates with SIM-based IoT sensors to activate or deactivate the sensors; a data processing module that converts raw data received from the sensors into usable or readable information; a customer relationship management (CRM) database module in which user details and sensor data relating to the user are stored; an analytics module that receives information from the data processing module and determines accuracy of the received information; and a reporting module that receives the analyzed information from the analytics module and generates customized reports in real-time or near-real-time based on a request from an associated party and on the received information.

### BACKGROUND

In related art usage based and behavior based insurance systems, an insurance company receives usage or behavior based information regarding a user and constructs an appropriate insurance plan for the user based on the received information.

A user must submit a request to the insurance company to view the information regarding the user's usage or behavior that has been collected by the insurance company. In related art systems, however, the insurance company controls the collected information. Further, the insurance company manages user requests for collected information as well as the generation of reports in response to the user requests.

It may be inconvenient for a user to submit a user request and to wait the amount of time necessary for the insurance company to generate the report in response to the user request. Additionally, a user of related art systems has no way of verifying the accuracy of the report generated by the insurance company. Similarly, an automotive insurance provider using related art systems has no way to validate to the user that the collected usage or behavior based information was actually gathered by the vehicle sensor at an appropriate time, e.g., while the vehicle is being used instead of at rest. Further, a user of multiple types of insurance provided by different insurance companies must submit requests to each insurance company independently in order to receive an independent report or reports from each insurance company. There is no way to provide to the user a comprehensive report of information collected by all insurance companies.

It may also be inconvenient for the insurance company to generate such reports for different users, who may request different types of information or may wish to view the information in different formats.

### SUMMARY

According to embodiments, converged systems and methods are provided for receiving raw data from IoT sensors (e.g., SIM-based sensors) that may be associated with multiple insurance providers, converting the raw data into usable or readable information, and providing the usable or readable information to all associated parties including users, insurance companies, and other suitable parties such as management companies and other service providers.

The converged systems and methods may include a customer relationship management (CRM) module in which user details and sensor data relating to the user are stored; a provisioning module that communicates with IoT sensors to activate or deactivate the sensors; a data processing module that converts raw data received from the sensors into usable or readable information; an analytics module that receives information from the data processing module and determines accuracy of the received information; and a reporting module that receives a request from an associated party and generates customized reports based on analyzed information from the analytics module and generates customized reports in real-time or near-real-time based on a request from an associated party and on the received information.

The converged systems and methods may activate or deactivate IoT sensors, and may record the activation or deactivation thereof in a database included in the CRM module to improve the accuracy of collected information.

The converged systems and methods may accommodate various insurance providers and other service providers.

The converged systems and methods may automatically alert, in real-time, appropriate associated parties whenever data is received from the IoT sensors that is unusual.

The converged systems and methods may provide customized real-time or near-real-time reports to users upon request, and the user may be ensured that the information in the reports is accurate.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 illustrates a system for providing usage or behavior based insurance information according to an embodiment;

FIG. 2 illustrates a customer resource management (CRM) module according to an embodiment;

FIG. 3 illustrates a data processing module according to an embodiment;

FIG. 4 illustrates an analytics module according to an embodiment;

FIG. 5 illustrates a reporting module according to an embodiment;

FIG. 6 illustrates a method for processing information received from a service provider according to an embodiment;

FIG. 7 illustrates a method for providing a usage and/or behavior-based report to a user, according to an embodiment;

FIG. 8 shows an overall process of provisioning a sensor device and generating and outputting usage/behavior-based data according to sensor data from the sensor device, in accordance with an embodiment;

FIG. 9 illustrates a process of issuing an unusual activity alert according to an embodiment;

FIG. 10 illustrates a system for providing usage or behavior based insurance information according to an embodiment;

FIG. 11 is a diagram of an example environment in which systems and/or methods, described herein, may be implemented; and

FIG. 12 is a diagram of example components of a device according to an embodiment.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

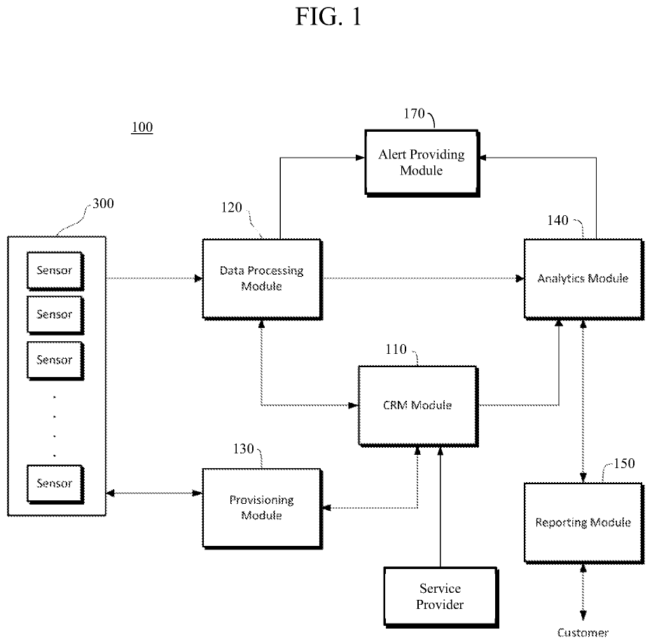

FIG. 1 shows a system 100 for providing usage or behavior based insurance information according to an embodiment.

Referring to FIG. 1, according to an embodiment, a system 100 for providing usage or behavior based insurance information may include a customer relationship management (CRM) module 110, a data processing module 120, a provisioning module 130, an analytics module 140, a reporting module 150, and an alert providing module 170.

The system 100 may receive raw data from a plurality of Internet of Things (IOT) sensors 300, each of which may be a device or may be equipped on a device associated with an insurance company and/or with a customer of an insurance company. For example, an IoT sensor 300 may be equipped on an insured vehicle, on a wearable device of a user having health insurance, on a wearable device of a pet belonging to a user having pet insurance, in a home covered by home insurance, on a vehicle belonging to a fleet that is subject to a fleet management system, and the like. In one or more embodiments, the IoT sensors 300 may include one or more Subscriber Identity Module (SIM) based sensors, e.g., sensors communicatively coupled to one or more SIMs such as a standard SIM (2FF), Micro-SIM (3FF), Nano SIM (4FF), embedded SIM (eSIM), for example, MFF2, and any other suitable types of SIM. In one or more embodiments, the sensors communicatively coupled to the SIMS may include, for example, temperature sensors, humidity sensors, pressure sensors, proximity sensors, level sensors, accelerometers, gyroscopes, gas sensors, infrared sensors, optical sensors, and any other types of sensors that may be suitable for capturing the usage or behavior of a user. The sensors may capture the usage or behavior of a user in the form of raw data and may provide the raw data to the system 100 via SIM-based technologies.

The system 100 may receive the raw data from the plurality of IoT sensors 300 by way of, for example, a radio access network (RAN) and/or an IoT device data gateway. A RAN by way of which the raw data may be received by the system 100 may include, for example, any one or more of a 2G, 3G, 4G, 5G, or any other suitable telecommunications technology. However, the system 100 is not limited thereto, and may receive the raw data from the IoT sensors 300 by way of any wired or wireless communication.

The system 100 may also receive requests for information from one or more users. The users of the system 100 may include, for example, various insurance companies, management companies (for example, fleet management companies, property management companies, and the like), and insured customers of the various insurance companies. The requests for information may include requests for reports including information, stored within the system 100, that has been gathered by the IoT sensors 300. The requests for information may be specific to the information gathered from a specific IoT sensor 300, information gathered in association with a customer, information gathered in association with an insured customer of an insurance company, or the like. The requests for information may specify any one or more of a particular report format of a plurality of report formats, one or more attributes of a plurality of attributes, or one or more particular types of information to be included in the report.

The system 100 may receive the requests for information from any one or more of the users including the various insurance companies, the management systems, and the insured customers of the various insurance companies.

The system 100 may output information reports including usage or behavior based insurance information in response to receiving the reports from the customers. Based on the received request, the reports may be formatted in any one of a plurality of formats, may include one or more attributes, or may include one or more particular types of information.

The system 100 may also output an alert to one or more customers or service providers (e.g., insurance company) when the raw data received from one or more of the IoT sensors 300 indicates that an unusual event has occurred. For example, the system 100 may output a first alert when raw data received from an IoT sensor 300 indicates that the sensor 300 is activated at the same time as a time when data held within the system 100 indicates that the IoT sensor 300 should be inactive. As another example, the system 100 may output a second alert when raw data received from an IoT sensor 300 includes information suggestive of an unusual event. For example, an IoT sensor 300 equipped on a vehicle may transmit any one or more of acceleration information, braking information, and speed information of the vehicle to the system 100 and may further transmit information indicating unusual acceleration, unusual braking, or unusual speed to the system 100.

The CRM module 110 is connected or communicably connectable to a plurality of different service providers (e.g., insurance companies, fleet management companies, etc.) and may receive and hold the customer data of the service providers and their related IOT sensor device data. The CRM module 110 may also receive and/or transmit, to/from one or more service providers (e.g., fleet management company), connected device data. Provisioning of customer devices is performed via the CRM module 110. For example, an order with respect to a customer may be received (e.g., from a service provider), based on which the CRM module 110 instructs to provision one or more IoT sensors 300 with respect to that customer.

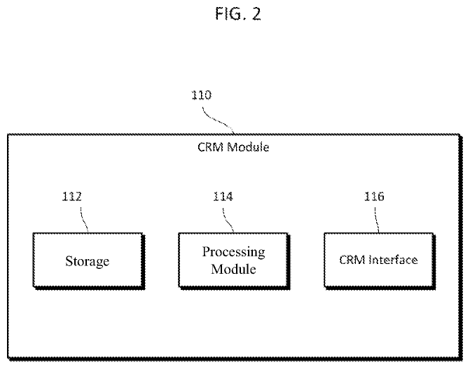

FIG. 2 shows a CRM module 110 according to an embodiment.

Referring to FIG. 2, the CRM module 110 may include a storage 112, a processing module 114, and a CRM interface 116 to receive customer information.

The CRM interface 116 may receive information from service providers (e.g., insurance companies). The information received by the CRM module 110 from the service providers may include customer and/or device information to be used by the analytics module 140 (to be described below) to analyze data received from the IoT sensors 300 and provide analysis results to the reporting module 150. The customer and/or device information is stored in the storage 112 (e.g., database, resource file, customer data platform (CDP), etc.).

In one or more embodiments, the CRM interface 116 may receive order information with respect to customers, e.g., a customer order to a service provider. The order information may be received from the service provider.

The CRM processing module 114 may transmit or submit provisioning instructions or requests to the provisioning module 130 to activate or deactivate one or more IoT sensors 300, based on the order information received via the CRM interface 116. Further, the CRM processing module may receive, from the provisioning module 130, device status information with respect to the IoT sensors 300 for storage in the storage 112 (e.g., in association with the corresponding customer information). The device status information may indicate a device that is provisioned to a particular customer, and an activation or deactivation status of the device. Based on the device status information stored in the storage 112, the CRM processing module 114 may provide or transmit, to the data processing module 120, responses to sensor status requests that are received from the data processing module 120. The CRM processing module 114 may also retrieve customer information from the storage 112 and transmit the customer information to the analytics module 140.

The storage 112 may store customer information and/or IoT sensor information. The customer information may include, for example, a customer identification (ID) for each customer, a type or types of insurance provided to each customer, and information regarding the user's device/property under insurance (for example, a device ID or a customer's Mobile Directory Number (MDN)) The information regarding each of the IoT sensors 300 may include, for example, an IoT sensor ID, an international mobile subscriber identity (IMSI) of each of the IoT sensors 300, a status of the IoT sensor (for example, as active or inactive), information related to the activation time of each of the IoT sensors 300, and the like. The information about the IoT sensors 300 such as the current status, activation time, and the like, may be received, for example, from the provisioning module 130.

In related art systems, although a user may be a customer of a plurality of insurance companies, each of the plurality of insurance companies conventionally has an independent service provision system and data processing system. Accordingly, the user may be required to communicate directly with each one of the insurance companies in order to obtain information reports from each of the associated insurance companies.

In an embodiment, a user of different types of insurance companies may conveniently acquire (for example, via the system 100) information reports (e.g., analytics, usage reports, behavior reports, etc.) in relation to one or more services from different types of insurance companies to which the user is a customer

Referring back to FIG. 1, the provisioning module 130 may receive information from the CRM module 110 for activating or deactivating one or more IoT sensors 300. As described above, the CRM module 110 may transmit provisioning information or instructions to the provisioning module 130 based on, for example, receipt of information from a service provider (e.g., customer order information).

The provisioning module 130 may activate or deactivate IoT sensors 300 according to the received information.

The provisioning module 130 may also receive status information from the IoT sensors 300 according to whether the IoT sensors 300 are activated or deactivated. The provisioning module 130 may transmit the received status information to the CRM module 110 to be stored in association with customer information in the storage 112.

The data processing module 120 collects sensor data from the provisioned IoT sensors 300, and processes the data so as to be analyzed and/or reported to a user or a service provider. In some embodiments, the data processing module 120 also receives device status information (or sensor status information in response to sensor status requests) from the CRM module 110. For example, the data processing module 120 may receive information indicating a device status (activated or deactivated in accordance with the provisioning or order information) from the CRM module 110 (as stored in the storage 112). Based on the device status information, the data processing module 120 may detect an anomaly or unusual behavior (e.g., sensor device continuing to be collected from an IoT sensor that has been deactivated, received data indicating unusual or alarming behavior, etc.), and output an alert to a user (e.g., customer or system administrator) and/or service provider.

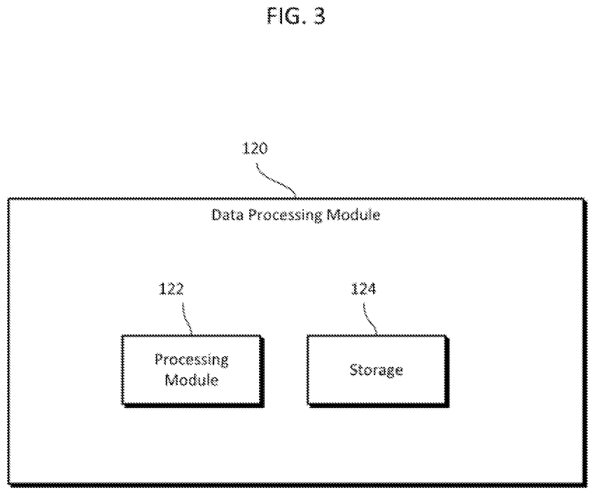

FIG. 3 shows a data processing module 120 according to an embodiment.

Referring to FIG. 3, the data processing module 120 may include a processing module 122 to process raw data received from the plurality of IoT sensors 300, a storage 124 for storing a predetermined set of rules or instructions to process the raw data, and an alert providing module 126 to provide an alert to a user indicating the occurrence of an unusual event.

The data processing module 120 may receive raw data from the plurality of IoT sensors 300 by way of, for example, one or more RANs and the data gateway(s). The processing module 122 (e.g., one or more processors) of the data processing module 120 may then perform processing functions on the raw data so as to be readable by a user and/or the analytics module 140. The processing module 122 may also perform processing operations such as encoding, decoding, normalization, filtration, enrichment, etc., and may then transmit processed data to the CRM module 110 and to the analytics module 140. In one or more embodiments, the data gateway is included as a part of the data processing module 120.

The received raw data may include a plurality of fields. For example, if the IoT sensors 300 are monitoring behavior/usage of a vehicle driver who is a holder of a vehicle insurance policy, the plurality of fields may include a number of times of hard braking of the vehicle, a number of times of sudden acceleration of the vehicle, and the like. In this case, each IoT sensor 300 of the plurality of IoT sensors 300 may transmit one or more fields of data by way of the RAN to the system 100.

The processing module 122 may normalize the raw data by organizing the received raw data according to a predetermined set of rules, stored in the storage 124, to form the processed data. For example, the processing module 122 may filter the received raw data by selectively removing one or more fields from the received raw data to form the processed data. Further, the processing module 122 may enrich the raw data by adding one or more fields to form the processed data. The added one or more fields may be generated by the processing module 122 based on other fields received in the raw data from the IoT sensors 300.

The data processing module 120 may transmit the processed data to the analytics module 140. The data processing module 120 may also store the processed data in a processed data database (e.g., associated with or included in the data processing module 120). In other embodiments, the processed data may be stored in the storage 112.

The processing module 122 may be configured to detect an abnormality or an unusual event. For example, when raw or processed data received from an IoT sensor 300 includes a field indicating that an unusual event has occurred, the processing module 122 may detect or determine this unusual event and send a notification (e.g., including at least one of an indication or identification of the unusual event, details of the unusual event, a time stamp, location information, device identification information, customer identification information, service provider information, etc.) to the alert providing module 170. To this end, the processing module 122 may immediately send the notification to the alert providing module 170, such that the alert providing module 170 can then provide an alert to the associated user in real-time/near real-time. For example, when raw or processed data from an IoT sensor 300 equipped on a vehicle is received that includes a field indicating unusual acceleration, braking, or speed (e.g., as compared against a predetermined threshold in the data processing module 120, as indicated by a flag in the raw data, etc.), the alert providing module 170 may transmit an alert to one or more associated users to alert the one or more users of the unusual behavior. The alert may be transmitted via a wireless and/or wired communication means, and may be in the form of at least one of an e-mail, a text message, an application notification, etc.

In accordance with one or more embodiments, since the abnormal or unusual event is detected at the data processing module 120, the alarm may be issued in real time or near real time.

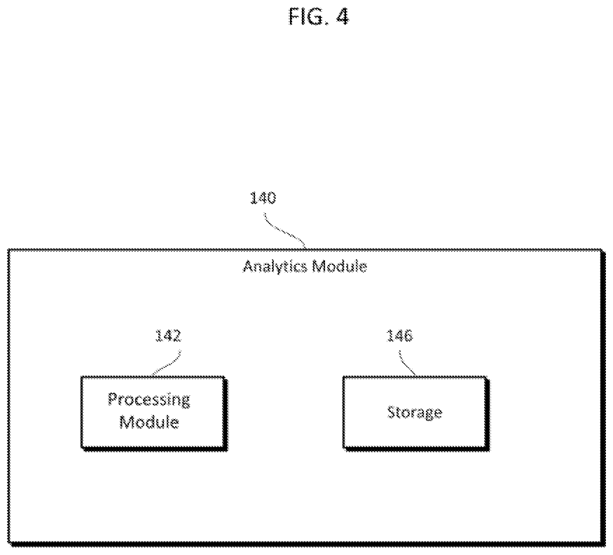

Referring back to FIG. 1, the analytics module 140 retrieves or receives the processed data from the data processing module 120 and performs predetermined analytics processes or solutions on the processed data to provide various analytics, verify the accuracy of the processed data, etc. The analyzed data or analysis results may be stored in an analyzed data database (e.g., in the storage 146 of FIG. 4) and is provided to the reporting module 150.

The analytics module 140 may also receive customer related information from the CRM module 110 (i.e., from the storage 112) and perform analytics processes, provide analysis results, and/or store the analysis results based on the customer related information. For example, the analytics module 140 may map, combine, and/or associate the device related information (e.g., processed sensor data) received from the data processing module 120 to the customer related information (e.g., customer identification information, provisioned device information corresponding to a customer, device status information for a customer's device(s)) received from the CRM module 110.

Further, the analytics module 140 may detect an abnormality based on the device related information and the customer related information, such as reception of device related information from an IoT sensor that has not been provisioned or that has been deactivated. The analytics module 140 may report this abnormality (e.g., via an alarm signal and/or the reporting module 150) to at least one of a user (e.g., customer), service provider, system administrator, etc., via the alarm providing module 170.

FIG. 4 shows an analytics module 140 according to an embodiment.

Referring to FIG. 4, the analytics module 140 may include a processing module 142 to perform analysis (e.g., behavior analysis, accuracy analysis, etc.) on received data and a storage 146.

The analytics module 140 may receive processed data from the data processing module 120 and information that has been stored in the storage 112 of the CRM module 110. The analytics module 140 may also receive information regarding a report request from the reporting module 150.

The processing module 142 may perform usage and/or behavior analysis on the received data from the data processing module 120 and the CRM module 110. Further, the processing module 142 may perform accuracy analysis on the received data.

The processing module 142 may be configured to detect an abnormality or an unusual event, such as a mismatch. For example, when the processing module 142 detects a mismatch between the sensor data obtained from the CRM module 110 and the processed data from the data processing module 120 (e.g., sensor data received from an IoT sensor that is not activated, provisioned to another user, etc.), or when the processing module 142 detects a negative trend in the analyzed customer usage/behavior (e.g., the user has used more force on the breaking pedal in last X days indicating a deteriorated vehicle breaking system, pet's heart rate irregular for past Y days indicating a potential heart disease, etc.), the processing module 142 may send a notification (e.g., including at least one of an indication or identification of the unusual event, details of the unusual event, a time stamp, location information, device identification information, customer identification information, service provider information, etc.) to the alert providing module 170. As described above, the alert providing module 170 can then provide an alert to the associated user via a wireless and/or wired communication means.

The storage 146 may store the results of the behavior analysis and the accuracy analysis. The storage 146 may also store information to be retrieved by the reporting module upon receipt of a user's request for generating a report. In some embodiments, the storage 146 of the analytics module may also store the processed data received from the data processing module 120 and may store the information retrieved from the storage 112.

Referring back to FIG. 1, the reporting module 150 is configured to provide data visualizations based on the analyzed data of the analytics module 140. To this end, the reporting module 150 is accessible by the service providers and/or the customers of the service providers, and stores configurations in dedicated configuration profiles based on which customized dashboarding/reporting of the analyzed data. Here, the dashboarding or reporting may be provided in real time or near real time. Further, the configurations may be customized by corresponding customers and/or service providers, so as to provide the reporting in a manner preferred by each user.

The reporting module 150 may be accessed via a portal or dashboard by users registered to the system. In this regard, the reporting module may authenticate a corresponding user based on a registered user name and password, and allow the user (e.g., a customer or service provider) to configure the reporting (e.g., dashboard, data visualization, etc.) for that user and to view reports generated based on the configuration.

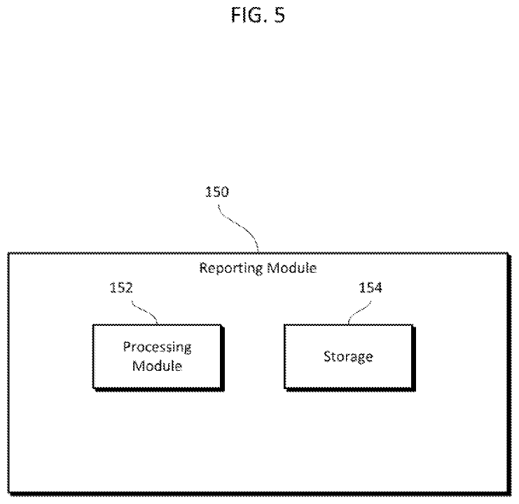

FIG. 5 shows a reporting module 150 according to an embodiment.

Referring to FIG. 5, the reporting module 150 may include a processing module 152 configured to output an interface for customizing a report, to generate a configuration profile accordingly, and to generate a report or data visualization based on the configuration profile. For example, the customized report may be a usage and/or behavior report, an insurance payment report, a report including different types of insurance associated with the user, and the like. The storage 154 is configured to store information regarding each user (e.g., configuration profiles).

The processing module 152 may receive a user request for generating a customized report. Based on the received user request, the processing module 152 may retrieve information from the storage 146 of the analytics module 140 and may store, in the storage 154, information regarding each customer. For example, the storage 154 of the reporting module 150 may store each customer's preferred report configuration in a respective configuration profile and may provide the configuration profile to the processing module 152 so as to generate a customized report for each customer in real-time or near-real-time, according to the configuration profile, in response to a report request.

The processing module 152 may generate the customized report using a requested format and may provide the customized report to the user via the interface.

In accordance with one or more embodiments, the system 100 for providing usage or behavior based insurance information is a converged system, that provisions sensor devices, manages user data, and provides analytics and reports (e.g., usage and/or behavior based reports) for a plurality of different service providers. For example, service providers may receive orders for corresponding services (e.g., insurance policies) and submit those orders (including, e.g., customer information) to the system 100 in order for the system 100 to provision sensor devices and manage customer information based on the orders. Accordingly, a customer can conveniently access reports for a plurality of service providers to which the customer has contracted with via a single portal or dashboard provided by the system 100 (i.e., the reporting module 150). Moreover, the customer and/or service provider can customize the configuration of the report(s) so as to be able to view and/or present the analytical data in a preferred manner.

Further, in accordance with example embodiments, sensor data may be received, processed, and/or analyzed in real time. Accordingly, a customer or service provider may view analytical data that is based on the most up-to-date sensor data. Further, alerts in the case of a predetermined event (or anomaly) being detected may be immediately sent to a service provider or customer in real time or near real time. Raw sensor data may be continuously pushed by sensors 300 to the data processing module 120 (or device data gateway thereof or connected thereto), may be periodically pushed or pulled (e.g., in accordance with a predetermined schedule), and/or may be pushed or pulled in response to predetermined events or trigger events (e.g., in response to a threshold condition being satisfied, in response to detection of data, etc.). The raw sensor data may be processed by the data processing module (e.g., data processing application, microservice, etc.) in real time or near real time (i.e., in response to being received). Further, the processed data may be transferred to the analytics module 140 (e.g., an analytics application, microservice, etc.) via real time or event data streams (e.g., Kafka streams) and may be processed by the analytics module 140 in real time or near real time (i.e., in response to being received). Therefore, the analyzed data may be retrieved by the reporting module and reported or visualized by the user in real time or near real time.

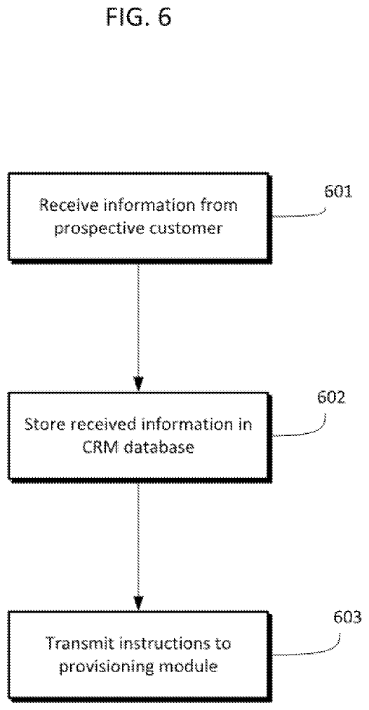

FIG. 6 shows a method for processing information received from a customer according to an embodiment.

Referring to FIG. 6, a process is described for receiving information from a service provider. The received information may be used to provision one or more IoT sensors 300 for use in obtaining usage and/or behavior based analytics for an insurance policy or usage/behavior-based policy of a server provider.

At step 601, the CRM interface 116 may receive information from a service provider (for example, one or more insurance companies, fleet management companies, etc.). The received information may include, for example, at least one of customer identification information (e.g., name, age, gender, e-mail address, contact information, home address, work address, customer ID, etc.), a type or types of insurance provided to the customer, information on one or more devices (e.g., types of devices, SIM card information of the devices, etc.) to be provisioned to the customer, etc. The process proceeds to step 602.

At step 602, the CRM interface 116 may cause the received information to be stored in the storage 112. The received information may be stored in association with one or more IoT sensors 300. For example, the received information may associate a received customer ID with identification information of one or more IoT sensors 300. For example, when a user identified by the received customer ID has health insurance, the received customer ID may be associated with identification information of an IoT sensor equipped on a wearable device worn by the user. The received information may be used in managing an insurance policy for the customer. The process proceeds to step 603.

At step 603, the CRM processing module may transmit, to the provisioning module 130, instructions for provisioning the one or more IoT sensors 300 to be used in managing the insurance policy. The one or more IoT sensors 300 may already be possessed by the customer (in which case the provisioning process would register or connect the sensor device to the system 100 so as to provide sensor data for analytics processing and reporting), may be issued to the customer by the service provider (in which case the provisioning process would register or connect the sensor device to the system 100 so as to provide sensor data for analytics processing and reporting), and/or may be issued by the system 100 to the customer (e.g., may be ordered for delivery to the customer and registered in association with the user to obtain data for analytics processing and reporting).

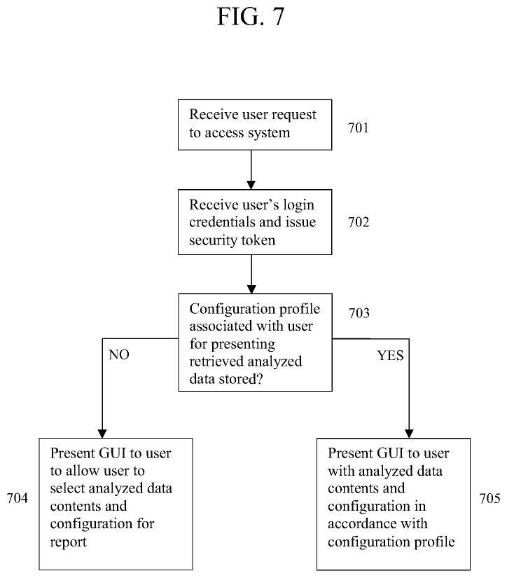

FIG. 7 shows a method of providing a usage and/or behavior-based report to a user, according to an embodiment.

Referring to FIG. 7, at step 701, a user request to access the system 100, i.e., the reporting module 150, is received. In this case, the system 100 (i.e., processing module 152) identifies that the user has not yet logged in to the system 100 and directs the user to a login page (e.g., provided by a user authentication service, security service, etc.). The user may be a customer of one or more service providers integrated into the system 100, or may a service provider (i.e., an employee or user of a service provider).

At step 702, the user's login credentials (e.g., username, user ID, password, etc.) are received via user input to the login page. The user is then authenticated based on the login credentials (e.g., by the user authentication service, security service, etc.). Based on the successful authentication, a security token containing information of the user is issued and provided to the reporting module 150.

At step 703, the processing module 152 identifies the user based on the security token and retrieves analyzed data from the storage 146 of the analytics module 140. According to another embodiment, the analyzed data may not be (or may only partially be) previously generated and stored in the storage 146, but may be generated in real time (and based on the most up-to-date processed data) in response to a user access to the reporting module and/or a user request for a report. At step 703, the processing module 152 further determines whether a configuration profile associated with the user is stored in the storage 154. If yes (e.g., if the user has previously logged into the system and has used the reporting module and/or configured a customized reporting configuration), the process proceeds to step 705. If no (e.g., if the user is logging in for the first time or has not previously configured a reporting configuration), the process proceeds to step 704. According to another embodiment, if no configuration profile is dedicatedly or specifically associated with the user, a default configuration profile may be used and the process may proceed to step 705 in all cases.

At step 704, the processing module 152 generates (based, for example, on the retrieved information and a default presentation template) and presents a graphical user interface (GUI) to the user. The GUI allows the user to select various data parameters to be presented on a report, and select the locations of those parameters on the report (e.g., via drag-and-drop, etc.). For example, the GUI may include a list presenting the information associated with the user (e.g., each insurance or service that the user is subscribed to, the user's usage/behavior parameters associated with each insurance, the analytical results such as accuracy level of each information, etc.). The GUI may also include a plurality of interactive elements (e.g., button, drop-down list, filter, search box, etc.) to allow the user to configure the presentation format and/or contents of the report. The processing module 152 will monitor or identify the interactions between the user and the interactive elements and create a configuration profile for the user based on the interaction. The configuration profile is then stored in the storage 154 of the reporting module 150.

At step 705, the processing module 152 retrieves the configuration profile associated with the user from the storage 154, and generates a report (e.g., GUI) based on the configuration profile and the retrieved analyzed data. The report is presented to the user (i.e., output for display on a client terminal of the user). The report (e.g., GUI) may include a list of information and a plurality of interactive elements, such as described with reference to step 704, but may be customized to the user by being presented in accordance with the user's configuration profile.

The reports (GUIs) output in steps 704 and 705 may be configured by the user such that less than all of the available data is selected to be output. Further, the reports may periodically refresh (e.g., in accordance with a predetermined time interval or in response to a user request) in order to update the analysis data based on real-time data from the sensor devices 300.

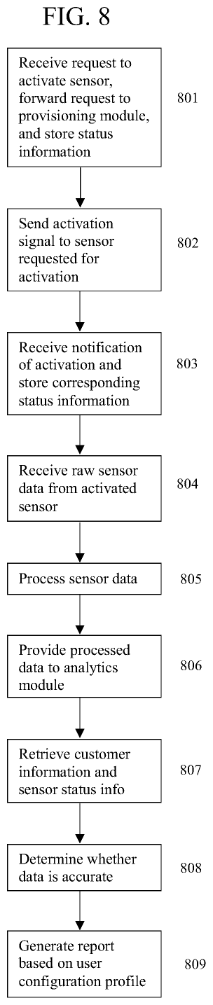

FIG. 8 shows an overall process of provisioning a sensor device and generating and outputting usage/behavior-based data according to sensor data from the sensor device, in accordance with an embodiment.

Referring to FIG. 8, at step 801, a user (e.g., from an insurance company) sends a request (via CRM interface 116) to activate an IoT sensor. The CRM processing module forwards the request to the provisioning module 130, and stores status information (e.g., “Activation Attempted on XXX”) in the storage 112.

At step 802, the provisioning module 130 determines (based on the activation request) which IoT sensor is required to be activated, and sends an activation signal to said sensor.

At step 803, based on the IoT sensor being activated, a notification (including a current status, such as “Activated successfully) is provided by the IoT sensor to the provisioning module 130. The provisioning module 130 will then store the associated information (e.g., “Current Status: Activated”, “Activation Attempt Successful,” associated time stamp, etc.) in the storage 112. If the activation of the IoT sensor fails, a notification (which may include a reason for the failure or information (e.g., a code) indicative of a failure reason) is provided by the IoT sensor to the provisioning module 130, and the provisioning module 130 will then store the associated information (e.g., “Current Status: Deactivated,” “Activation Attempt Failed,” associated time stamp, reason for activation failure, etc.) in the storage 112 and the process may end (alternatively, the service provider may be informed or alerted to the failure, the activation attempt may be repeated a predetermined number of times, etc.). If the activation attempt succeeds, the process proceeds to step 804.

At step 804, the activated IoT sensor 100 captures the usage and/or behavior of the user and provides raw sensor data to the processing module 122 via a RAN and/or an IoT device gateway, as described above.

At step 805, the processing module 122 of the data processing module 120 processes (e.g., normalizes) raw data received from the activated IoT sensor into system readable and/or meaningful data. In some embodiments, the processing module 122 may determine (based on the processed data) whether or not an unusual incident has occurred (e.g., temperature of the vehicle is abnormally high or above a preset threshold, abnormal heartbeat as compared to a threshold. The processing module 122 may initiate or instruct the alert providing module 170 to provide an alert to the associated user (e.g., at least one of the customer, insurance company, etc.) based on the unusual attempt being detected or determined.

At step 806, the processing module 122 provides the processed data to the analytics module 140.

At step 807, the processing module 142 of the analytics module 140 receives the processed data from the processing module, and retrieves the associated customer information (e.g., customer information, insurance plan, etc.) and sensor information (e.g., sensor status) from the storage 112.

At step 808, based on the received data, the processing module 142 of the analytics module 140 determines whether or not the processed data is accurate. For example, the processing module 142 may use the sensor status from the storage 112 to determine whether there is a mismatch with the sensor status (e.g., sensor data being collected from a deactivated sensor, or from a sensor that is not registered or provisioned for the customer in a case where the sensor data also includes a customer or user identifier, etc.). If the processing module 142 determines that there is a mismatch between the sensor status included or derived from the processed data and the sensor status provided by the CRM module 110 (e.g., the former indicates that the sensor has been activated for 10 hours but the latter indicates that the sensor has only been activated for 1 hour, etc.), the processing module 142 will determine that the provided data has low accuracy and may include an indicator (e.g., a flag, etc.) to the data. Accordingly, an alert may be immediately issued (e.g., by instructing or sending a notification to the alert providing module 170 to alert the associated user) or, when the reporting module 150 generates a report including this data, the reporting module 150 can present this low accuracy issue in a distinctive manner (e.g., highlighted, bold, etc.).

In one or more embodiments, the analyzed data is stored in the storage 146. In at least some embodiments, the analyzed data may be generated periodically or may be generated based on processed data being received. In at least some embodiments, the analyzed data may be generated based on up-to-date and real time data, and in response to a request from the reporting module 150 (e.g., based on a user logging in and requesting to view a report).

At step 809, when generation of a report is requested or required, the processing module 152 of the reporting module 150 retrieves the analyzed data from the storage 146 (or requests the analytics module 140 to generate and/or provide analyzed data), retrieves the user's configuration profile (if any) from the storage 154, and generates a customized report for the user based on the retrieved data, as described above.

It is understood that, in at least some embodiments, one or more of the storage 112, storage 124, storage 146, and storage 154 may be external to its respective module, e.g., may be in a centralized data storage, a cloud cluster, etc.

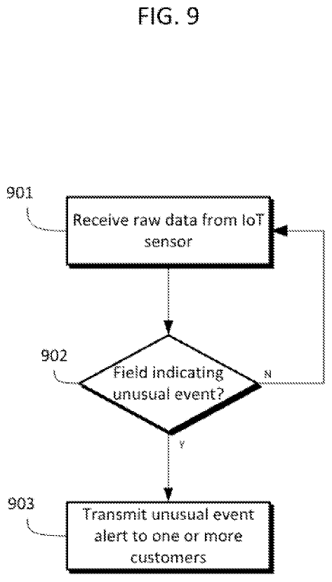

FIG. 9 shows a process of issuing an unusual activity alert performed by the data processing module 120 according to an embodiment.

At step 901, the data processing module 120 receives raw data from an IoT sensor 300. For example, the raw data received from the IoT sensor 300 may include one or more fields indicating that an unusual event has occurred.

For example, when raw data is received from an IoT sensor 300 equipped on a vehicle, the raw data may include at least one from among a field indicating unusual acceleration, a field indicating unusual braking, and a field indicating unusual speed of the vehicle. The process proceeds to step 902.

At step 902, the data processing module 120 determines whether an unusual event has occurred using the at least one from among the field indicating unusual acceleration, the field indicating unusual braking, and the field indicating unusual speed of the vehicle. When the data processing module 120 determines that the unusual event has occurred, the process proceeds to step 903. When the data processing module 120 determines that the unusual event has not occurred, a notification is sent to the alert providing module 170 and the process proceeds back to step 903.

At step 903, the alert providing module 170 transmits an alert to one or more associated customers that a mismatch has occurred. The one or more associated customers may be determined using the information regarding the IoT sensor 300 retrieved from the storage 112.

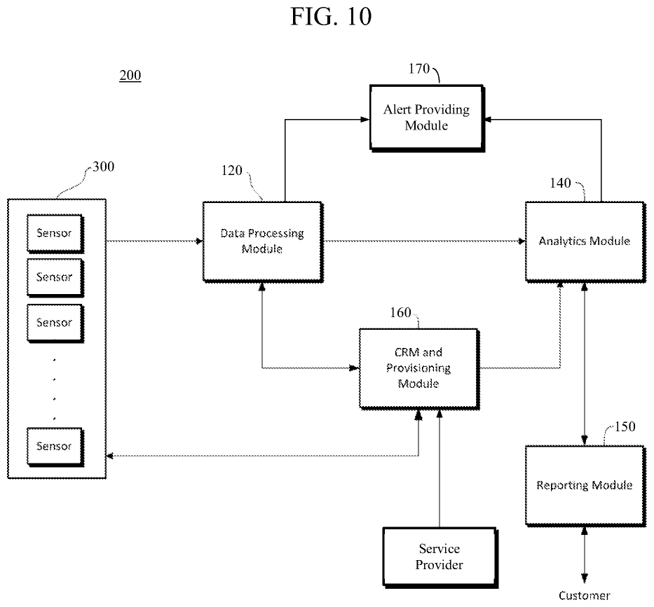

FIG. 10 shows a system 200 for providing usage or behavior based insurance information according to an embodiment. Elements of FIG. 10 that are the same as those of FIG. 1 will not be described in detail below.

Referring to FIG. 10, according to an embodiment, a system 200 for providing usage or behavior based insurance information may include a CRM and provisioning module 160, a data processing module 120, an analytics module 140, a reporting module 150, and an alert providing module 170.

The CRM and provisioning module 160 may include a storage, a processing module, a CRM interface to receive customer information, and a provisioning module. The storage, processing module, and CRM interface may be the same as those shown in FIG. 2, and the provisioning module may be the same as that shown in FIG. 1. The system 200 of FIG. 10 is different from the system 100 of FIG. 1 in that the CRM and provisioning module 160 of FIG. 10 is an integrated device including the CRM module 110 of FIG. 1 and the provisioning module 130 of FIG. 1.

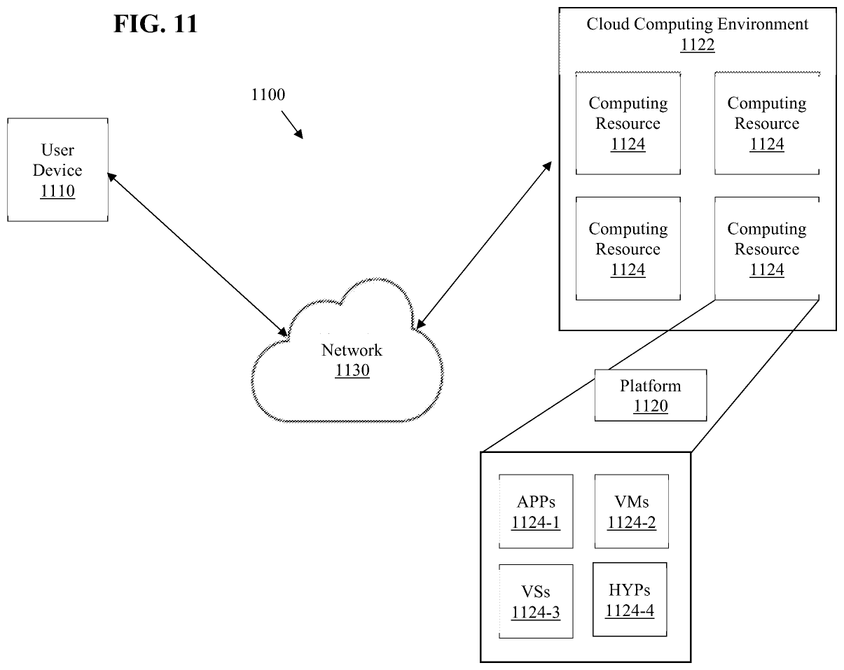

FIG. 11 is a diagram of an example environment 1100 in which systems and/or methods, described herein, may be implemented. As shown in FIG. 11, environment 1100 may include a user device 1110, a platform 1120, and a network 1130. Devices of environment 1100 may interconnect via wired connections, wireless connections, or a combination of wired and wireless connections. In embodiments, any of the functions and operations described with reference to FIGS. 1 through 10 above may be performed by any combination of elements illustrated in FIG. 11.

User device 1110 includes one or more devices capable of receiving, generating, storing, processing, and/or providing information associated with platform 1120. For example, user device 1110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 1110 may receive information from and/or transmit information to platform 1120.

Platform 1120 includes one or more devices capable of receiving, generating, storing, processing, and/or providing information. In some implementations, platform 1120 may include a cloud server or a group of cloud servers. In some implementations, platform 1120 may be designed to be modular such that certain software components may be swapped in or out depending on a particular need. As such, platform 1120 may be easily and/or quickly reconfigured for different uses.

In some implementations, as shown, platform 1120 may be hosted in cloud computing environment 1122. Notably, while implementations described herein describe platform 1120 as being hosted in cloud computing environment 1122, in some implementations, platform 1120 may not be cloud-based (i.e., may be implemented outside of a cloud computing environment) or may be partially cloud-based.

Cloud computing environment 1122 includes an environment that hosts platform 1120. Cloud computing environment 1122 may provide computation, software, data access, storage, etc., services that do not require end-user (e.g., user device 1110) knowledge of a physical location and configuration of system(s) and/or device(s) that hosts platform 1120. As shown, cloud computing environment 1122 may include a group of computing resources 1124 (referred to collectively as “computing resources 1124” and individually as “computing resource 1124”).

Computing resource 1124 includes one or more personal computers, a cluster of computing devices, workstation computers, server devices, or other types of computation and/or communication devices. In some implementations, computing resource 1124 may host platform 1120. The cloud resources may include compute instances executing in computing resource 1124, storage devices provided in computing resource 1124, data transfer devices provided by computing resource 1124, etc. In some implementations, computing resource 1124 may communicate with other computing resources 1124 via wired connections, wireless connections, or a combination of wired and wireless connections.

As further shown in FIG. 11, computing resource 1124 includes a group of cloud resources, such as one or more applications (“APPs”) 1124-1, one or more virtual machines (“VMs”) 1124-2, virtualized storage (“VSs”) 1124-3, one or more hypervisors (“HYPs”) 1124-4, or the like.

Application 1124-1 includes one or more software applications that may be provided to or accessed by user device 1110. Application 1124-1 may eliminate a need to install and execute the software applications on user device 1110. For example, application 1124-1 may include software associated with platform 1120 and/or any other software capable of being provided via cloud computing environment 1122. In some implementations, one application 1124-1 may send/receive information to/from one or more other applications 1124-1, via virtual machine 1124-2.

Virtual machine 1124-2 includes a software implementation of a machine (e.g., a computer) that executes programs like a physical machine. Virtual machine 1124-2 may be either a system virtual machine or a process virtual machine, depending upon use and degree of correspondence to any real machine by virtual machine 1124-2. A system virtual machine may provide a complete system platform that supports execution of a complete operating system (“OS”). A process virtual machine may execute a single program, and may support a single process. In some implementations, virtual machine 1124-2 may execute on behalf of a user (e.g., user device 1110), and may manage infrastructure of cloud computing environment 1122, such as data management, synchronization, or long-duration data transfers.

Virtualized storage 1124-3 includes one or more storage systems and/or one or more devices that use virtualization techniques within the storage systems or devices of computing resource 1124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 1124-4 may provide hardware virtualization techniques that allow multiple operating systems (e.g., “guest operating systems”) to execute concurrently on a host computer, such as computing resource 1124. Hypervisor 1124-4 may present a virtual operating platform to the guest operating systems, and may manage the execution of the guest operating systems. Multiple instances of a variety of operating systems may share virtualized hardware resources.

Network 1130 includes one or more wired and/or wireless networks. For example, network 1130 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 11 are provided as an example. In practice, there may be additional devices and/or networks, fewer devices and/or networks, different devices and/or networks, or differently arranged devices and/or networks than those shown in FIG. 11. Furthermore, two or more devices shown in FIG. 11 may be implemented within a single device, or a single device shown in FIG. 11 may be implemented as multiple, distributed devices. Additionally, or alternatively, a set of devices (e.g., one or more devices) of environment 1100 may perform one or more functions described as being performed by another set of devices of environment 1100.

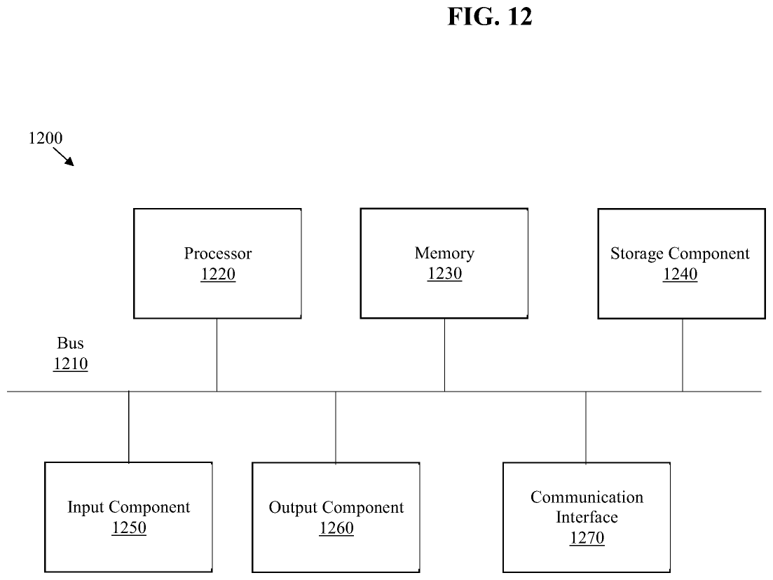

FIG. 12 is a diagram of example components of a device 300. Device 1200 may correspond to user device 1110 and/or platform 1120. As shown in FIG. 12, device 1200 may include a bus 1210, a processor 1220, a memory 1230, a storage component 1240, an input component 1250, an output component 1260, and a communication interface 1270.

Bus 1210 includes a component that permits communication among the components of device 1200. Processor 1220 may be implemented in hardware, firmware, or a combination of hardware and software. Processor 1220 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 1220 includes one or more processors capable of being programmed to perform a function. Memory 1230 includes a random access memory (RAM), a read only memory (ROM), and/or another type of dynamic or static storage device (e.g., a flash memory, a magnetic memory, and/or an optical memory) that stores information and/or instructions for use by processor 1220.

Storage component 1240 stores information and/or software related to the operation and use of device 1200. For example, storage component 1240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 1250 includes a component that permits device 1200 to receive information, such as via user input (e.g., a touch screen display, a keyboard, a keypad, a mouse, a button, a switch, and/or a microphone). Additionally, or alternatively, input component 1250 may include a sensor for sensing information (e.g., a global positioning system (GPS) component, an accelerometer, a gyroscope, and/or an actuator). Output component 1260 includes a component that provides output information from device 1200 (e.g., a display, a speaker, and/or one or more light-emitting diodes (LEDs)).

Communication interface 1270 includes a transceiver-like component (e.g., a transceiver and/or a separate receiver and transmitter) that enables device 1200 to communicate with other devices, such as via a wired connection, a wireless connection, or a combination of wired and wireless connections. Communication interface 1270 may permit device 1200 to receive information from another device and/or provide information to another device. For example, communication interface 1270 may include an Ethernet interface, an optical interface, a coaxial interface, an infrared interface, a radio frequency (RF) interface, a universal serial bus (USB) interface, a Wi-Fi interface, a cellular network interface, or the like.

Device 1200 may perform one or more processes described herein. Device 1200 may perform these processes in response to processor 1220 executing software instructions stored by a non-transitory computer-readable medium, such as memory 1230 and/or storage component 1240. A computer-readable medium is defined herein as a non-transitory memory device. A memory device includes memory space within a single physical storage device or memory space spread across multiple physical storage devices.

Software instructions may be read into memory 1230 and/or storage component 1240 from another computer-readable medium or from another device via communication interface 1270. When executed, software instructions stored in memory 1230 and/or storage component 1240 may cause processor 1220 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 12 are provided as an example. In practice, device 1200 may include additional components, fewer components, different components, or differently arranged components than those shown in FIG. 12. Additionally, or alternatively, a set of components (e.g., one or more components) of device 1200 may perform one or more functions described as being performed by another set of components of device 1200. In embodiments, any one of the operations or processes of FIGS. 1 through 10 may be implemented by or using any one of the elements illustrated in FIGS. 11 and 12.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components or modules described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

What is claimed is:

1. A system for providing usage or behavior based insurance information, comprising:
a customer relationship management (CRM) module configured to receive information on at least one customer for generating a usage or behavior based insurance policy, the CRM module comprising a database configured to store information associated with the at least one customer;
a data processing module configured to receive raw data from a plurality of Internet of Things (IOT) sensors and to process the raw data to form processed data;
an analytics module configured to receive the processed data from the data processing module and the information associated with the at least one customer from the CRM module, and to generate analysis data based on the received processed data and on the received information; and
a reporting module configured to receive a report request from a customer and to generate a report including usage or behavior based insurance information based on the analysis data.

2. The system of claim 1, further comprising a provisioning module configured to receive information from the CRM module for activating or deactivating at least one from among the plurality of IoT sensors and to activate or deactivate the at least one from among the plurality of IoT sensors according to the received information.

3. The system of claim 1, wherein, for each customer of the at least one customer, the information associated with the customer comprises a customer identification (ID).

4. The system of claim 1, wherein, for each customer of the at least one customer, the information associated with the customer comprises a type of insurance provided to the customer.

5. The system of claim 1, wherein the report request received from the customer comprises a type of information to be included in the report and a format to be used to generate the report.

6. The system of claim 1, wherein the reporting module comprises a storage configured to store at least one customer profile, each customer profile of the at least one customer profile being associated with a respective customer of the at least one customer, and
wherein the reporting module is further configured to:
first determine whether a customer profile, associated with the customer from which the report request is received, is stored in the storage; and
generate the report based on the first determination.

7. The system of claim 6, wherein the reporting module is further configured to:
second determine whether the report request received from the customer includes a type of information to be included in the report; and
generate the report based on the second determination.

8. The system of claim 7, wherein the reporting module is further configured to, based on the first determination indicating that the customer profile is not stored in the storage and based on the second determination indicating that the report request received from the customer does not include the type of information to be included in the report, generate the report including a predetermined type of information.

9. The system of claim 6, wherein the at least one customer profile comprises a customer-preferred type of information to be included in the report, and
wherein the reporting module is further configured to, based on the first determination indicating that the customer profile is stored in the storage and based on the second determination indicating that the report request received from the customer does not include the type of information to be included in the report, generate the report including the customer-preferred type of information.

10. The system of claim 6, wherein the reporting module is further configured to:
second determine whether the report request received from the customer includes a format to be used to generate the report; and
generate the report based on the second determination.

11. The system of claim 10, wherein the reporting module is further configured to, based on the first determination indicating that the customer profile is not stored in the storage and based on the second determination indicating that the report request received from the customer does not include the format to be used to generate the report, generate the report using a predetermined format.

12. The system of claim 6, wherein the at least one customer profile comprises a customer-preferred format to be used to generate the report, and
wherein the reporting module is further configured to, based on the first determination indicating that the customer profile is stored in the storage and based on the second determination indicating that the report request received from the customer does not include the format to be used to generate the report, generate the report using the customer-preferred format.

13. The system of claim 1, wherein the data processing module further comprises a storage, and
wherein the database is configured to store information regarding each IoT sensor from among the plurality of IoT sensors in association with the at least one customer.

14. The system of claim 13, wherein the data processing module is further configured to:
retrieve information regarding an IoT sensor from among the plurality of IoT sensors; and
determine whether a mismatch has occurred between raw data received from the IoT sensor and the retrieved information.

15. The system of claim 14, further comprising an alert providing module configured to transmit a mismatch alert to the at least one customer based on the mismatch being detected.

16. The system of claim 13, further comprising an alert providing module,
wherein the raw data received from the plurality of IoT sensors comprises a field indicating whether an unusual event has occurred, and
wherein alert providing module is configured to transmit an unusual event alert to the at least one customer associated with an IoT sensor based on the data processing module detecting the field of the raw data received from the IoT sensor indicating that the unusual event has occurred.

17. A method for providing usage or behavior based insurance information, the method comprising:
receiving information on at least one customer for generating a usage or behavior based insurance policy;
storing information associated with the at least one customer in a database;
receiving raw data from a plurality of Internet of Things (IOT) sensors and processing the raw data to form processed data;
generating analysis data based on the processed data and on the received information associated with the at least one customer;
receiving a report request from a customer; and
generating a report including usage or behavior based insurance information based on the analysis data.
